(19) United States
(12) Patent Application Publication
(10) Pub. No.: US 2014/0230600 A1
(43) Pub. Date: Aug. 21, 2014

(54) Air Pump

(71) Applicant: Wei-Chi Wang, Tainan City (TW)

(72) Inventor: Wei-Chi Wang, Tainan City (TW)

(21) Appl. No.: 13/769,947

(22) Filed: Feb. 19, 2013

(51) Int. Cl. G05G 1/44

(52) U.S. Cl. CPC G05G 1/44
USPC 74/512

(57) ABSTRACT

An air pump has a frame, a pedal pivotally mounted on the frame, and a pedal securing device rotatably mounted on the frame to selectively fix the pedal on the frame. The pedal securing device has two knobs and an eccentric shaft. The knobs respectively have a pivot portion and an operational portion mounted on an outer surface of the pivot portion. The eccentric shaft is connected with the knobs and has an eccentric part driven by the operational portion of one of the knobs. A user can turn one of the knobs by foot to drive the eccentric shaft to rotate, and then the eccentric part can selectively engage or disengage a hook of the pedal. Accordingly, the pedal securing device is easy to operate by foot and prevents a hand of the user from being contaminated.

### BACKGROUND OF THE INVENTION

1. Field of the Invention

The present invention relates to an air pump, and more particularly to an air pump having a pedal securing device for fixing a pedal on an air pump.

2. Description of Related Art

An air pump has a frame, a pedal, a cylinder and a pipe having a connecting head. The pedal has a front end and a rear end. A pivot shaft is inserted through a torsion spring and is connected to the front end of the pedal. The pedal is pivotally mounted on the frame with the pivot shaft. The rear end of the pedal is a free end. A rear end of the cylinder is pivotally mounted on the frame. A front end of the cylinder is pivotally mounted on a middle section of a bottom surface of the pedal. The pipe is connected to the cylinder. The connecting head of the pipe is connected with an object such as a tire, and then the pedal is repetitively pressed for driving a piston rod of the cylinder to inflate the tire. When the inflation of the tire is finished, the connecting head of the pipe is dismounted from the tire.

After each use, an elastic force of the torsion spring is applied to the pedal of the air pump, and then the rear of the pedal is moved away from the frame. Accordingly, the air pump occupies a lot of space and is inconvenient to store. Responsive to the drawback, a clasp is further provided to fix the pedal on the frame after the pedal is pressed on the frame for storage.

In the process of fixing the pedal on the frame by the clasp, a user must stoop to pick up the clasp to hook the pedal. The hand of the user touches the frame and the pedal that is frequently stepped by people. The clasp is inconvenient to operate and the hand of the user is easily contaminated.

To overcome the shortcomings, the present invention tends to provide an air pump to mitigate or obviate the aforementioned problems.

### SUMMARY OF THE INVENTION

The main objective of the invention is to provide an air pump having a pedal securing device to prevent the hand of the user from being contaminated and is easy to operate.

The air pump has a frame, a pedal, a torsion spring, a pivot rod, a cylinder and a pedal securing device. The frame has a front end and a rear end. The pedal is pivotally mounted on the frame and has a pivot end, a moving end and two hooks. The pivot end is adjacent to the front end of the frame. The moving end is opposite to the pivot end of the pedal. The hooks are respectively mounted on the moving end of the pedal. The torsion spring is located at the pivot end of the pedal. The pivot rod is inserted through the torsion spring and is connected to the pivot end of the pedal and the front end of the frame. The cylinder is mounted on the frame and is pivotally connected with the pedal.

The pedal securing device is rotatably mounted on the frame and has two knobs and an eccentric shaft. The knobs are arranged opposite each other and respectively have a pivot portion and an operational portion. The pivot potion has an outer surface, an inner surface and a side surface. The inner surface is opposite to the outer surface of the pivot portion. The side surface is defined between the outer surface of the pivot portion and the inner surface of the pivot portion. The operational portion is mounted on the outer surface of the pivot portion. The eccentric shaft is defined between and is connected with the knobs and has an eccentric part driven by the operational portion of one of the knobs.

The pedal securing device is rotatably mounted on a frame of the air pump to selectively fix a pedal of the air pump on the frame of the air pump. A user can turn one of the knobs by foot to drive the eccentric shaft to rotate, and then the eccentric part can selectively engage or disengage a hook of the pedal. Accordingly, the air pump having the pedal securing device is easy to operate by foot and prevents a hand of the user from being contaminated by contacting the pedal.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an air pump in accordance with the present invention;

FIG. 2 is another perspective view of the air pump in FIG. 1;

FIG. 3 is an enlarged partially exploded perspective view of the air pump in FIG. 2;

FIG. 4 is a side view in partial section of the air pump in FIG. 1, shown with a pedal fixed; and

FIG. 5 is a side view in partial section of the air pump in FIG. 1, shown with a pedal unfixed.

### DETAILED DESCRIPTION OF PREFERRED EMBODIMENT

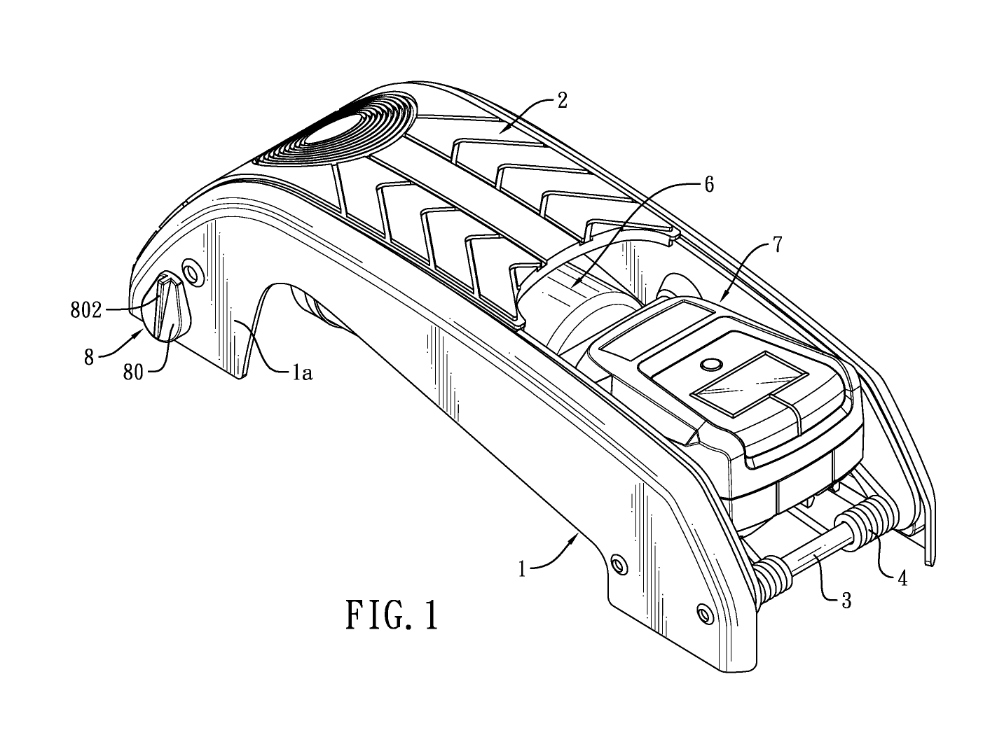

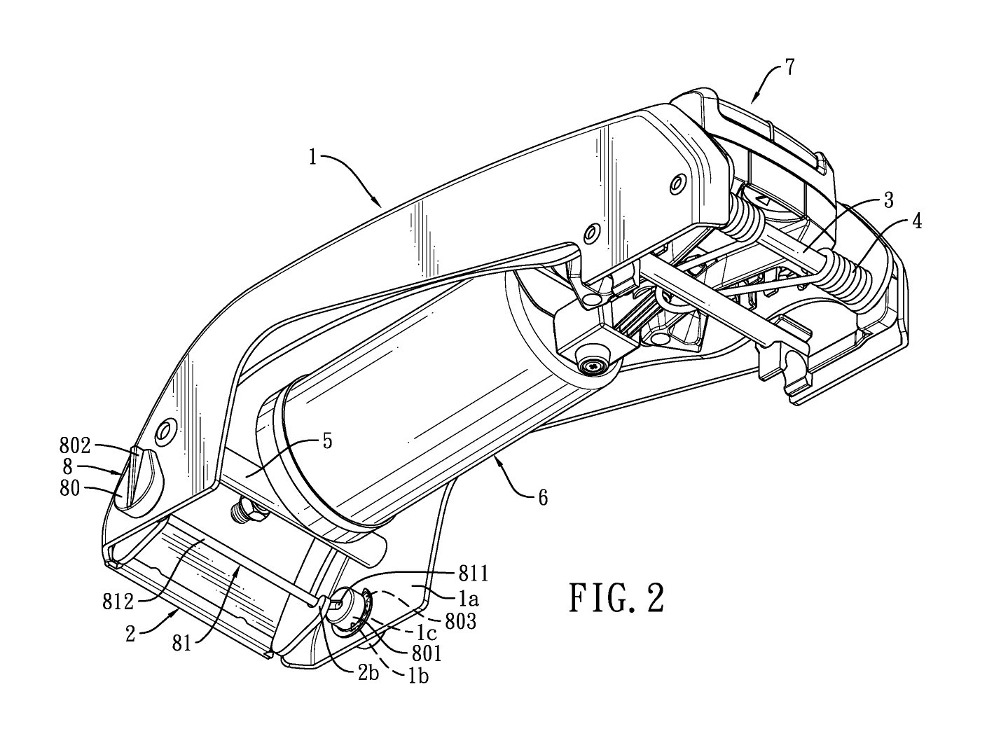

With reference to FIGS. 1 to 4, an air pump in accordance with the present invention comprises a frame 1, a pedal 2, a torsion spring 4, a pivot rod 3, a cylinder 6 and a pedal securing device 8, and further has a pressure gauge 7.

The frame 1 has a front end, a rear end, two side panels 1a and a connecting rod 5. The connecting rod 5 is connected with the side panels 1a of the frame 1 and is adjacent to the rear end of the frame 1. The pedal 2 is pivotally mounted on the frame 1 and has a pivot end, a moving end and two hooks 2b. The pivot end is adjacent to the front end of the frame 1. The moving end is opposite to the pivot end of the pedal 2. The hooks are respectively mounted on the moving end of the pedal 2. The torsion spring 4 is located at the pivot end of the pedal 2. The pivot rod 3 is inserted through the torsion spring 4 and is connected to the pivot end of the pedal 2 and the front end of the frame 1.

The cylinder 6 is mounted on the frame 1 and is pivotally connected with the pedal 2. The cylinder 6 has a cylinder housing and a cylinder core. The cylinder housing of the cylinder 5 is rotatably mounted on the pedal 2 via a pressing bar 2c of the pedal 2 and is pressed by the pressing bar 2c of the pedal 2. The cylinder core protrudes out of the cylinder housing and an outer end of the cylinder core is mounted on the connecting rod 5 of the frame 1. The cylinder housing of the cylinder 6 can connect with a pipe having a connecting head. Alternatively, the cylinder housing of the cylinder 6 can connect with the pressure gauge 7 and further connect the pipe having a connecting head.

The pedal securing device is mounted on the frame and has two knobs 80 and an eccentric shaft 81.

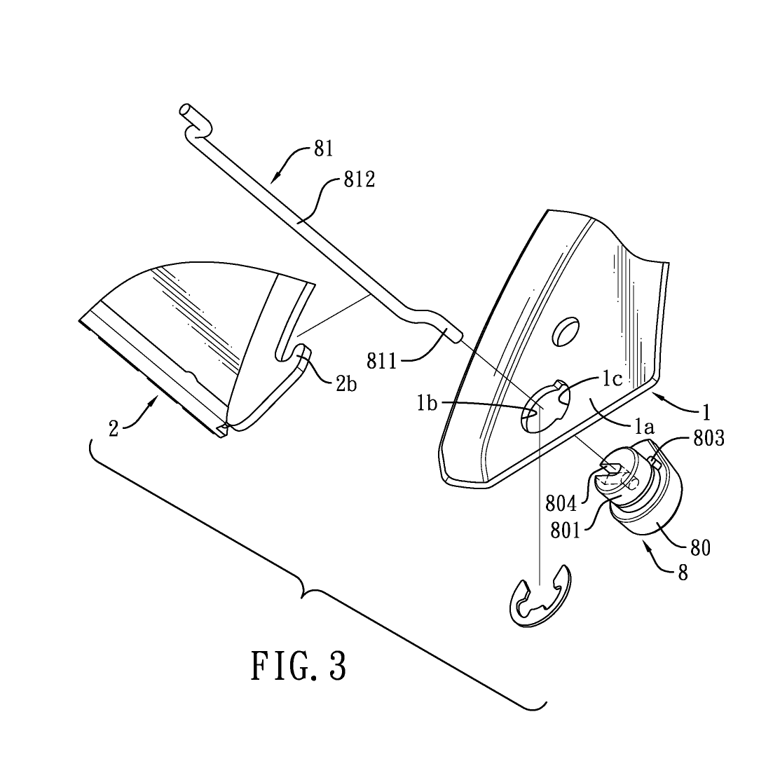

The knobs 80 are arranged opposite to each other, are mounted respectively on the side panels 1a of the frame 1 and respectively have a pivot portion 801 and an operational portion 802. The pivot portion 801 has an outer surface, an inner surface and a side surface. The inner surface is opposite to the outer surface of the pivot portion 801. The side surface is defined between the outer surface of the pivot portion 801 and the inner surface of the pivot portion 801. The operational portion 802 is mounted on the outer surface of the pivot portion 801. The pivot portion 801 of the knob 80 is mounted on a corresponding one of the side panels 1a of the frame 1 and is inserted through a hinge hole 1b that is formed through the corresponding side panel 1a. The operational portion 802 is located on an outer surface of the frame 1. Furthermore, a C-shaped ring engages the pivot portion 801 to fix the pivot portion 801 on the frame 1 and faces an inner surface of the frame 1. With reference to FIG. 3, the knobs 80 both have a connecting hole formed in the side surface of the pivot portion 801 and being an L-shaped hole. The knobs 80 both have a protrusion 803 formed on and protruding from the side surface of the pivot portion 801. The protrusion 803 is inserted into a position-limiting trough 1c of the hinge hole 1b to limit a rotating angle of the knob 80.

The eccentric shaft 81 is defined between and is connected with the knobs 80 and has an eccentric part 812 driven by the operational portion 802 of one of the knobs 80, and then the eccentric part 812 selectively engages the hooks 2b of the pedal 2 to fix the pedal 2 on the frame 1. With reference to FIG. 3, the eccentric shaft 81 has an eccentric part 812 and two connecting parts 811. The connecting parts 811 are respectively formed on and protrude from two ends of the eccentric part 812. The connecting parts 811 are both bent. The connecting parts 811 are respectively and securely inserted in the connecting holes 804 of the knobs 80.

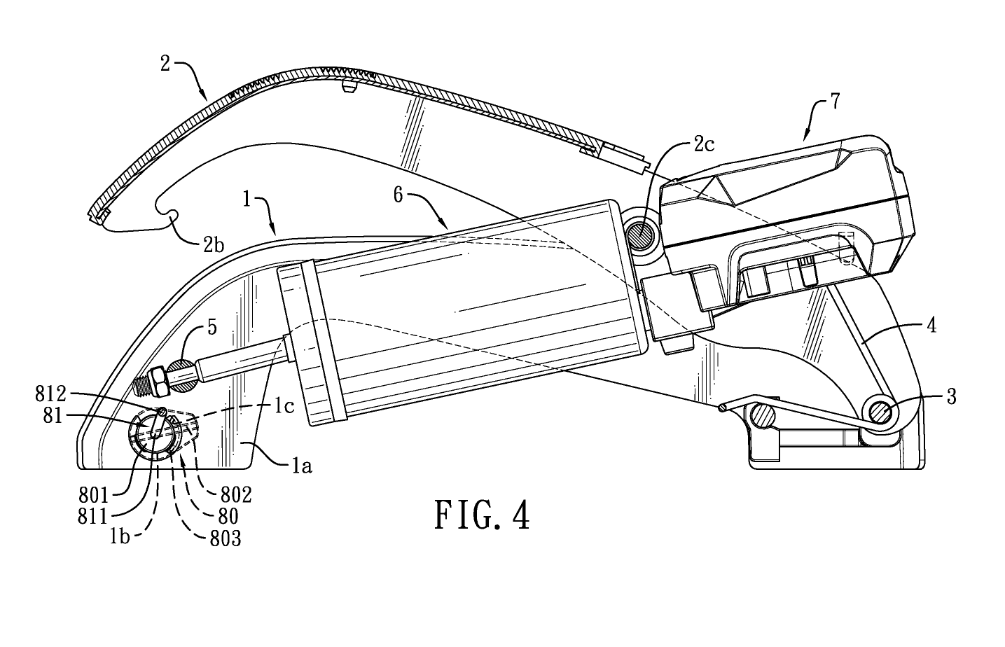

With reference to FIG. 4, the air pump can be put on the ground, and a user can turn one of the knobs 80 by foot to drive the eccentric shaft 81 to rotate, and then the eccentric part 812 disengages from the hooks 2b of the pedal 2. Therefore, the connecting head of the pipe of the air pump can be connected with a valve of a tire. The pedal is repetitively pressed for driving the cylinder core of the cylinder to inflate the tire. When the inflation of the tire is finished, the connecting head of the pipe is dismounted from the valve of the tire.

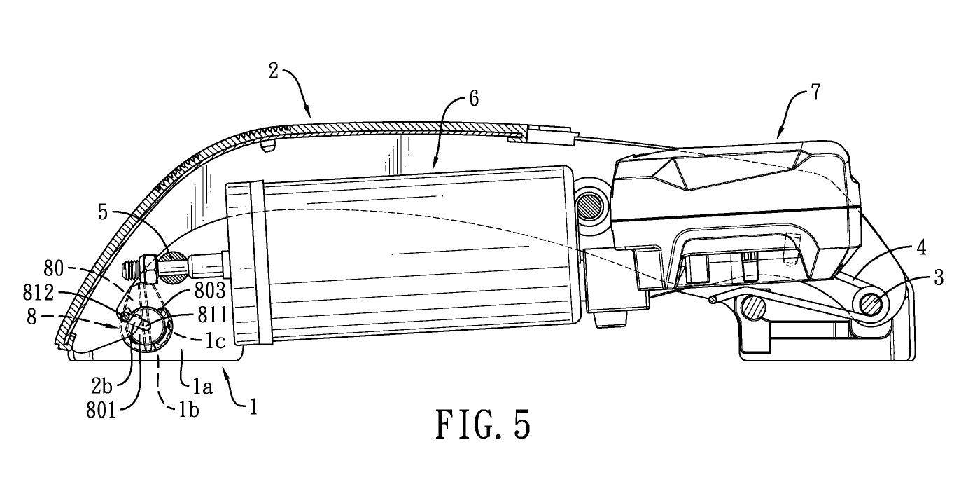

With reference to FIG. 5, one of the knobs 80 can be reversely turned by foot of the user, and then the eccentric part 812 engages the hooks 2b of the pedal 2 to fix the moving end of the pedal 2 on the frame 1. Accordingly, the pedal securing device 8 is easy to operate by foot of the user and prevents a hand of the user from being contaminated by contacting the pedal 2.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air pump comprising:
a frame having a front end and a rear end;
a pedal pivotally mounted on the frame and having
a pivot end adjacent to the front end of the frame;
a moving end opposite to the pivot end of the pedal; and
two hooks respectively mounted on the moving end of the pedal;
a torsion spring located at the pivot end of the pedal;
a pivot rod inserted through the torsion spring and connected to the pivot end of the pedal and the front end of the frame;
a cylinder mounted on the frame and pivotally connected with the pedal; and
a pedal securing device mounted on the frame and having
two knobs mounted on the frame, arranged opposite to each other and respectively having
a pivot portion having
an outer surface;
an inner surface opposite to the outer surface of the pivot portion; and
a side surface defined between the outer surface of the pivot portion and the inner surface of the pivot portion; and
an operational portion mounted on the outer surface of the pivot portion; and
an eccentric shaft defined between and connected with the knobs and selectively engaging the hooks of the pedal and having an eccentric part driven by the operational portion of one of the knobs.

2. The air pump as claimed in claim 1, wherein
the knobs respectively have
a connecting hole formed in the side surface of the pivot portion and being an L-shaped hole; and
the eccentric shaft has
two connecting parts being bent and respectively protruding from two ends of the eccentric part and respectively inserted in a corresponding one of the connecting hole of the knobs.

3. The air pump as claimed in claim 1, wherein the knobs respectively have a protrusion formed on and protruding from the side surface of the pivot portion.

4. The air pump as claimed in claim 2, wherein the knobs respectively have a protrusion formed on and protruding from the side surface of the pivot portion.
